(19) United States
(12) Patent Application Publication
(10) Pub. No.: US 2016/0022537 A1
(43) Pub. Date: Jan. 28, 2016

(54) Handling Useful Sauna Equipment

(71) Applicant: Seung Woo LEE, Yorba Linda, CA (US)

(72) Inventor: Seung Woo LEE, Yorba Linda, CA (US)

(21) Appl. No.: 14/340,310

(22) Filed: Jul. 24, 2014

(51) Int. Cl. A61H 33/06

(52) U.S. Cl. CPC A61H 33/067

(57) ABSTRACT

The present invention relates to a handling useful sauna equipment, more particularly a very convenient handling useful sauna equipment, which enables a lower body to move conveniently without a necessity of making the hip sit on a chair component and to enjoy sauna in a convenient posture, and which includes a chair portion that moves to and fro by a to-and-fro delivering means and a backrest fixed to the chair portion. According to the embodiment, since the chair portion is moved by the to-and-fro delivering means, even a handicapped user can position the lower body easily on a heater and use the sauna very easily.

### FIELD OF THE INVENTION

The present invention relates to a handling useful sauna equipment, more particularly a very convenient handling useful sauna equipment, which enables a lower body to move conveniently without a necessity of making the hip sit on a chair component and to enjoy sauna in a convenient posture.

### BACKGROUND OF THE INVENTION

In general, it has been well known that sauna is a hygiene that discharges body wastes accumulated in body outside the body through perspiration or sweat within a short time period for recovery from fatigue and skin health.

Usually, such sauna type applies high temperature above 40 degrees in Celsius directly to the body in an enclosed place making sweat discharged forcefully, and many such sauna products that can be used easily at homes have been on the market recently.

Such conventional sauna machines were disclosed in the Korean Utility Patent No. 20-328072 (titled “Home Sauna Machine”) and another Korean Utility Patent No. 20-328150 (titled “Portable Sauna Device”), in which a technology for preventing internal steam loss and increasing the efficiency of sauna.

In addition, Korean Utility Patent Application No. 10-2006-0077378 (titled “Dry Lower Body Sauna Device”) and Korean Utility Patent No. 20-0349944 (titled “Lower Body Only Sauna”) have been disclosed.

However, such conventional technologies have disadvantages that since a sitting chair component was provided fixedly in a sauna booth, for a handicapped user (for example, short-legged), when the user wanted to have the lower body close to a heater installed in the booth, the hip must be placed on an edge of the chair component and the enjoying of sauna was compromised due to the inconvenience.

### Problems to Solve

The present invention is to provide a handling useful sauna equipment, enabling a lower body to move conveniently without a necessity of making the hip sit on a chair component and to enjoy sauna in a convenient posture.

### Solutions to Problems

The invention provides a lower body sauna device comprising:

a chair portion configured for moving forward or backward by a to-and-fro delivering means; and

a backrest fixed to the chair portion.

Also, the backrest may be installed rotatably in the chair portion, and the backrest may be configured to be lied down or raised up in relation to to-and-fro movements of the chair portion through the to-and-fro delivering means.

Here, the to-and-fro delivering means may comprise:

a propping board on which a guide is installed; and

a moving member installed on a bottom surface of the chair portion and engaging the guide movably.

Also, in the invention, a backrest-holding member may be provided between the main body and the backrest, and wherein the backrest-holding member comprises:

a guide bracket installed in the main body and having a guide hole bored through a side surface; and

a protrusion installed in the backrest, inserted in the guide hole detachably and moving along the guide hole.

Also, in the invention, the backrest may further comprise a back heater, and the back heater may comprise:

a surface-type heat-generating body fixed to the backrest; and

a far-infrared-emitting member made of one selected from the group consisting of tourmaline, red clay, rock salt, germanium, elvan, jade, charcoal, and ceramic and installed so as to be exposed to one surface of the surface-type heat-generating body.

Also, in the invention, the backrest may further comprise a neckrest at a top end portion thereof.

### Effects of Invention

According to an embodiment of the invention, the sauna device is very convenient to use because a chair portion can be moved forward or backward by a to-and-fro delivering means and even a handicapped user can position the lower body close to the heater easily.

Also, according to the embodiment, since as the chair portion moves forward and backward by the to-and-fro delivering means, that is, through the guide and the moving member, the backrest's angle is adjusted to lie down or stand upright accordingly, it is very convenient and useful to enjoy sauna in a very comfortable and cozy state, and since the backrest is fixed rotatably at the chair portion through the first hinge, after the use, the backrest can be folded and stashed inside the main body and can be deployed for another use, so that the easiness of storing and convenience of usage increase.

Furthermore, according to the embodiment, since a heater is provided in the backrest, the heat can be delivered surely to portions (for example, the back) where heat could not reach very well, and thus the user can receive heat evenly all across entire body, maximizing the effect of sauna and enabling the user to expect a healing effect by heating intensively a specific portion (for example, the back portion).

### BRIEF DESCRIPTION OF DRAWINGS

FIGS. 1 and 2 are perspective views showing a handling useful sauna device according to the invention.

FIGS. 3 and 4 are assembling and disassembling perspective view showing major portions extracted of a handling useful sauna device according to the invention.

FIGS. 5 and 6 are cross-sectional views showing a handling useful sauna device according to the invention.

FIG. 7 is a perspective view showing a floor heater assembly extracted from a handling useful sauna device according to the invention.

FIG. 8 is a perspective views showing a handling useful sauna device according to another embodiment of the invention.

### DETAILED DESCRIPTION OF EMBODIMENTS OF INVENTION

Below, the invention is going to be described in detail referring to the Drawings.

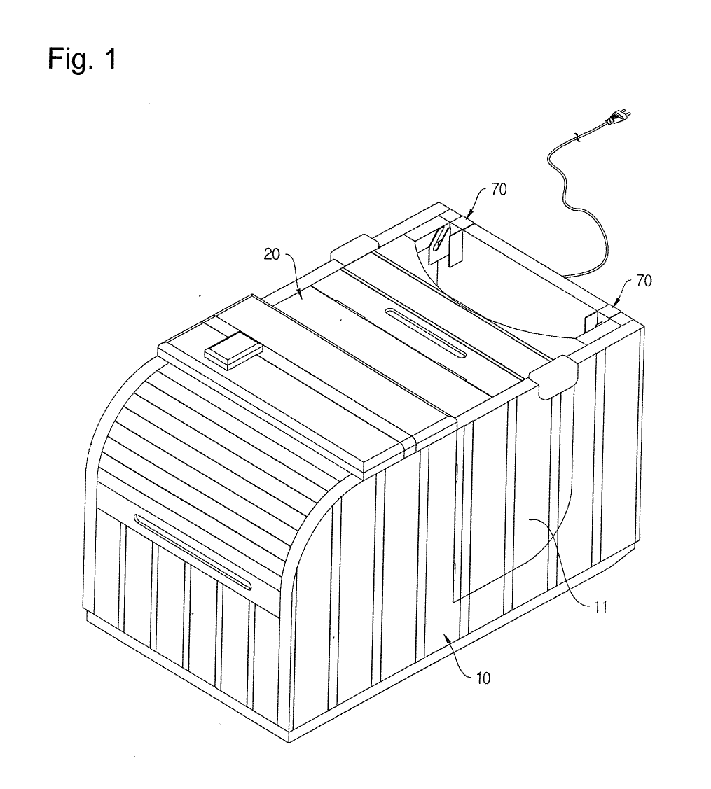

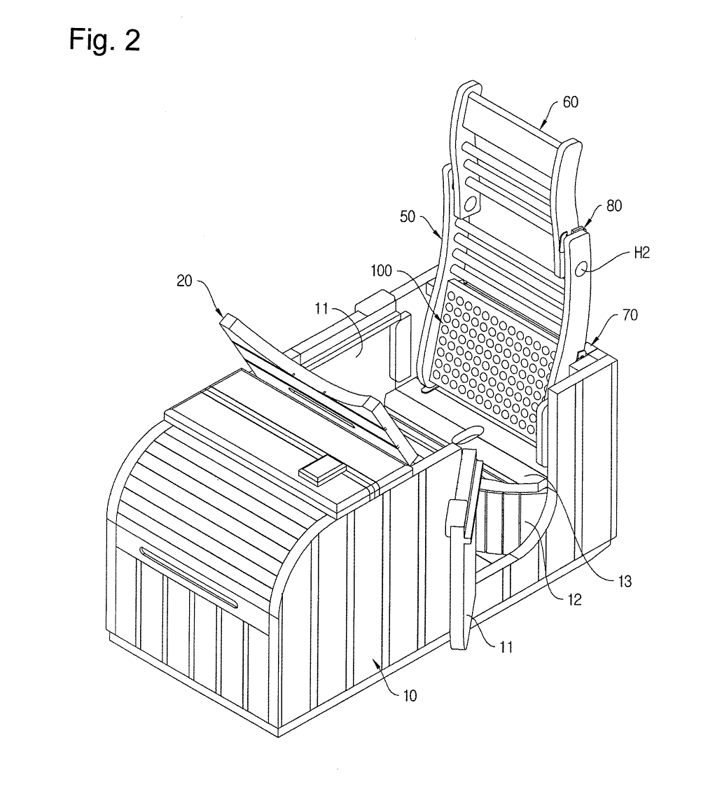

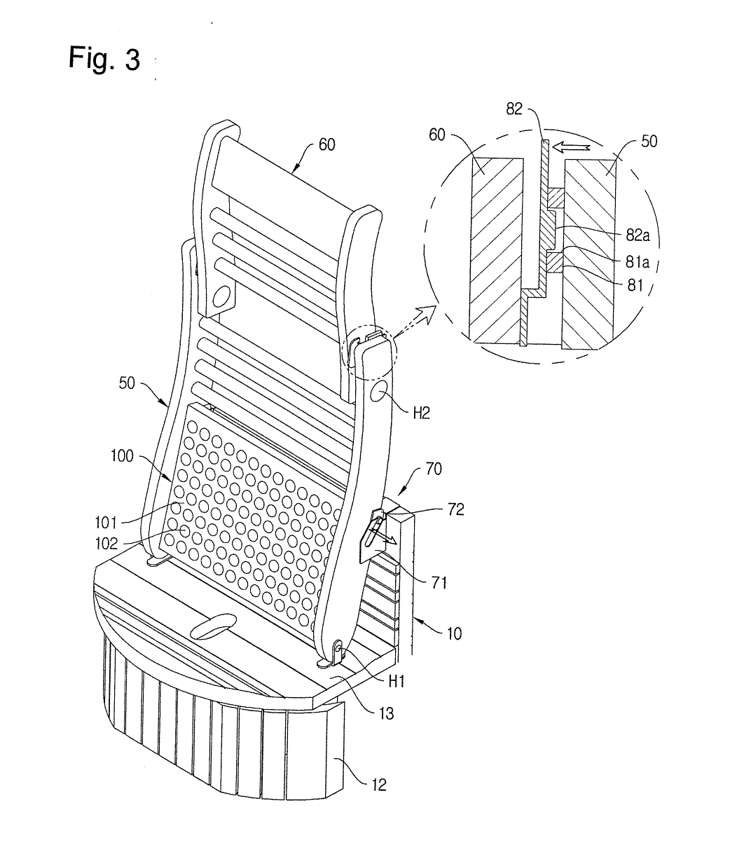

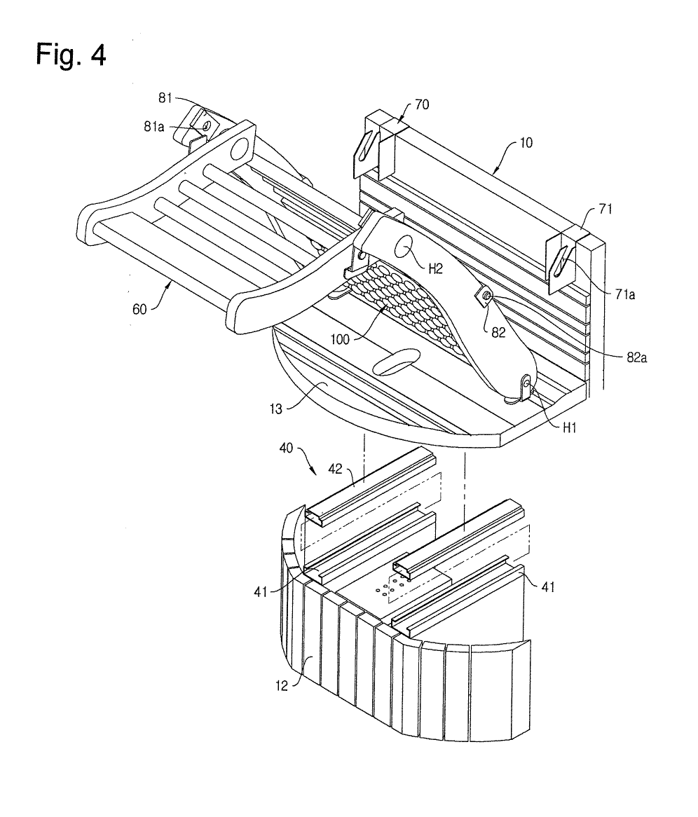

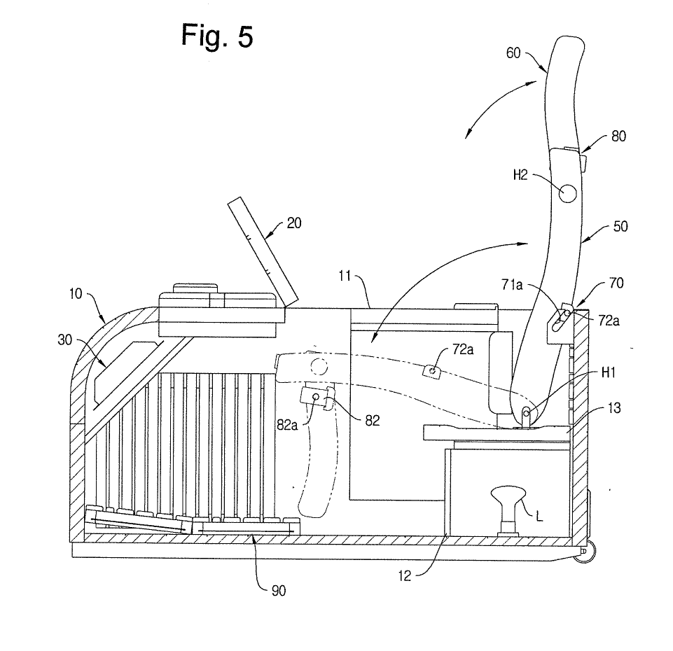

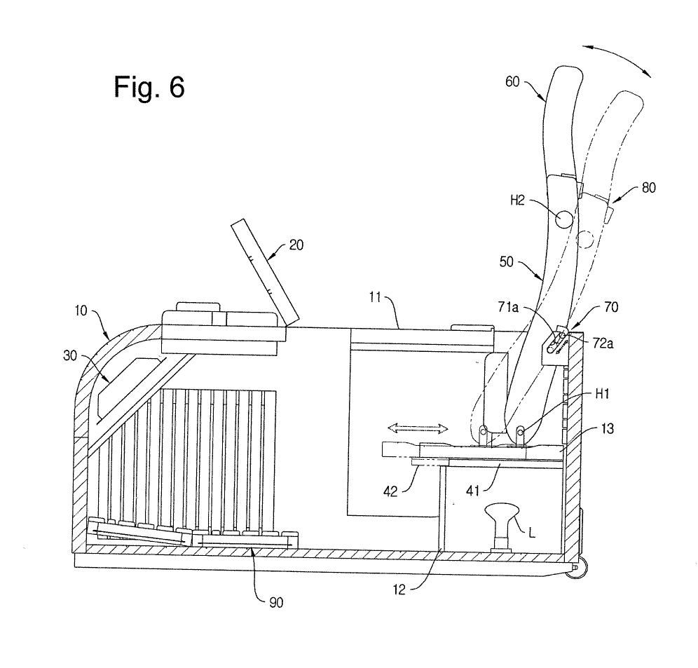

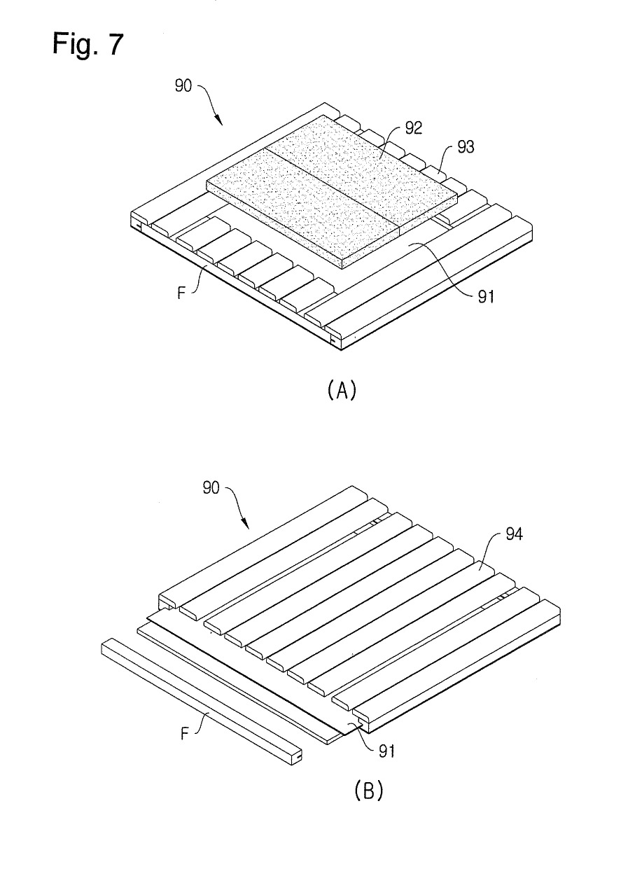

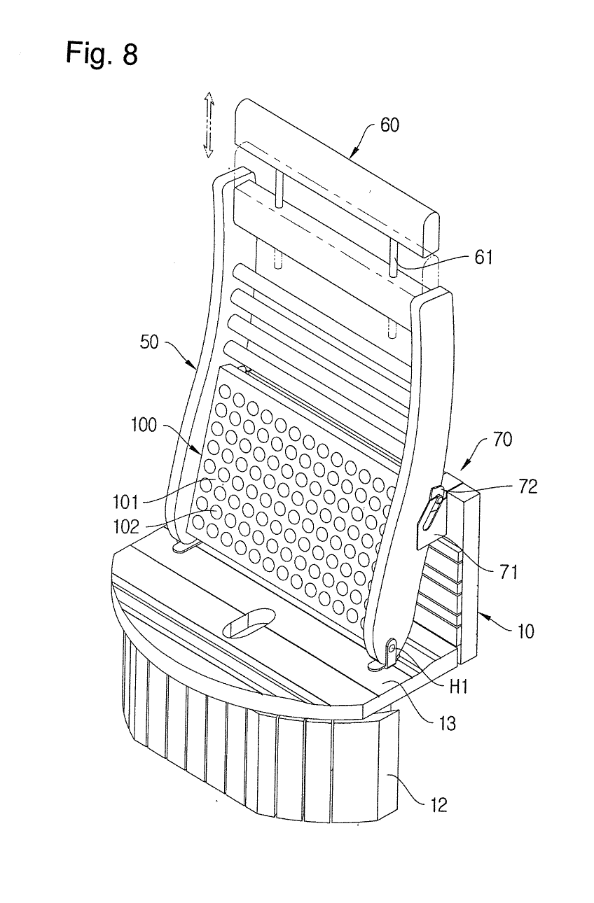

And, in order to explain the invention clearly, a half-body sauna is used as an example for description. FIGS. 1 and 2 are perspective views showing a handling useful sauna device according to the invention, FIGS. 3 and 4 are assembling and disassembling perspective view showing major portions extracted of a handling useful sauna device according to the invention, FIGS. 5 and 6 are cross-sectional views showing a handling useful sauna device according to the invention, FIG. 7 is a perspective view showing a floor heater assembly extracted from a handling useful sauna device according to the invention, and FIG. 8 is a perspective views showing a handling useful sauna device according to another embodiment of the invention.

Referring to FIGS. 1 through 7, a sauna device according to an embodiment of the invention includes a main body (10), a sliding cover (20), a heater (30), a to-and-fro delivering means (40), a backrest (50), a neckrest (60), a backrest-holding member (70), a neckrest-fixing member (80), a floor heater assembly (90), and a back heater (100).

Referring to FIGS. 1, 2, 5, and 6, the main body (10) has a shape of box generally, a receiving space for receiving lower body of user inside is provided, the top portion is opened to have the upper body of user protrude and exposed, a entrance door (11) is installed rotatably on both sides, and a chair portion (13) is provided at one side (rear) of inside so that the user may sit on.

Also, inside the prop (12) is installed a far-infrared lamp (L).

Referring to FIG. 1, FIG. 2, FIG. 5, and FIG. 6, the sliding cover (20) is installed slidingly movably in the main body (10), performing open-closing the exposed top portion of the main body (10).

Especially, in the case of the sliding cover (20), since the middle is connected through a hinge, it can be folded or unfolded.

Referring to FIG. 5 and FIG. 6, the heater (30) is a well-known heater, which is installed in the main body (10), more specifically, at a front-top, right and left sides, and floor, and supplied with electrical power and generates heat.

Especially, the floor heater assembly (90) installed on a floor of the main body (10) may be provided as shown in FIG. 7.

The floor heater assembly (90) includes a surface-type heat-generating body (91) that is supplied with electrical power from outside and generates heat and is inserted and fixed at a groove of an assembling frame (F), and is installed at the floor of the main body (10) along with the frame (F).

Especially, on the top surface of the surface-type heat-generating body (91) is installed a far-infrared radiating member (92), which is made in a plate with one selected from the group consisting of tourmaline, red clay, rock salt, germanium, elvan, jade, charcoal, and ceramic, and it can be made in well-known various shapes such as sphere and egg according to needs.

In the case of this embodiment, the far-infrared radiating member (92) is installed (fixed) on a top surface of the surface-type heat-generating body (91) through attaching means, which means anti-thermal silicon glue or anti-thermal double-side tape, and if they can perform the same function any can be applied.

Especially, in the inner side surface of the main body (10) with respect to the surface-type heat-generating body (91) is provided a footstool (93) for avoiding heat of the surface-type heat-generating body (91) for a time being.

It the case of this embodiment, the footstool (93) is formed on both of top surfaces of the frame (F).

According to the embodiment, when the foot is put on the far-infrared radiating member (92) and gets hot by heat of the surface-type heat-generating body (91) or the far-infrared radiating member (92) that was heated by the surface-type heat-generating body (91), the user can move the foot over to the footstool (93) fast, so that the user does not have to lift the foot repeatedly whenever the foot gets too hot as before, which is very convenient, and it has additional effects that the user does not dislike the usage because of the inconvenience, which is shown in FIG. 7(A).

Also, if necessary, as shown in FIG. 7(B), wooden bar (94) can be installed evenly instead of the far-infrared radiating member (92).

Referring to FIG. 4 and FIG. 6, a to-and-fro delivering means (40) is provided between the prop (12) and the chair portion (13), and the chair portion (13) can be moved to and fro through it.

The to-and-fro delivering means (40) comprises a guide (41) fixed on the prop (12), and a moving member (42) fixed on the bottom surface of the chair portion (13) and engaging movably to the guide (41).

In the embodiment, the guide (41) and the moving member (42) are made as LM guide type having female and male structures, wheels such as idler wheels may be installed in the moving member (42) or the guide (41), so that the user can move to and fro through the guide (41) and the moving member (42) while sitting on the chair portion (13).

According to the embodiment, since the chair portion (13) can move to and fro by the to-and-fro delivering means (40), even a handicapped user can put the lower body (feet) on the heater (30) easily and conveniently.

Referring to FIGS. 3 and 4, the backrest (50) is fixed detachably to the chair portion (13), supporting the back of the user.

IN the embodiment, since the backrest (50) is fixed obliquely and supports the user's back, the user can enjoy the sauna in more comfortable and stable state.

On the other hand, since the backrest (50) has a fixed angle, the user had to use the sauna in the same posture all the time.

Thus, by installing the backrest (50) rotatably in the chair portion (13) about the first hinge axle (H1), such inconveniences have been overcome. Referring to FIGS. 3 and 4, one end of an L-shaped bracket is fixed to the chair portion (13), and in the other end of the bracket is rotatably fixed an end of the backrest (50).

Especially, the backrest (50) is configured to lie down or stand up accordingly as the chair portion (13) is moved to and fro through the to-and-fro delivering means (40), and more specifically, as shown in FIG. 6, since the backrest (50) is in a state of being tilted slightly backwards and the center of mass is located in the rearward, if the chair portion (13) move forward the backrest (50) gets lied down slowly and automatically, and if the chair portion (13) moves rearwards to the contrary the backrest (50) returns to the initial state.

According to the embodiment, since the angle is changed so that the backrest (50) lies down or stands up accordingly as the chair portion (13) moves to and fro through the guide (41) and the moving member (42), the user can enjoy the sauna in a very comfortable and cozy state.

Also, as shown in FIG. 5, since the backrest (50) is fixed rotatably to the chair portion (13) through the first hinge axle (H1), the backrest (50) can be folded and stored inside after usage and unfolded for another usage, increasing the easiness and convenience of usage.

On the other hand, if the backrest (50) is pushed mistakenly when the backrest (50) is fixed to the chair portion (13) through the first hinge axle (H1) only, the backrest (50) may rotate with the first hinge axle (H1) as a center and strike the sliding cover (20) installed in the main body (10), causing a damage.

Then, the above problem may be solved by strengthening with a backrest-holding member (70) between the main body (10) and the backrest (50).

Referring to FIGS. 3 to 6, the backrest-holding member (70) comprises a guide bracket (71) and a fixing bracket (72), and performs a function of restricting the backrest (50) in this embodiment.

The guide bracket (71) is a box-type member with one side, top, and bottom opened in general, and in this embodiment, it is fixed to the main body (10) and performs a function of restraining guiding the fixing bracket (72).

And, a guide bracket (71a) that is opened obliquely is formed integrally on a side surface of the guide bracket (71), and a protrusion (72a) of the fixing bracket (72) engages the guide bracket (71a) movably.

The fixing bracket (72) is a member with the protrusion (72a) formed on one surface, fixed to the backrest (50) in this embodiment, and restrained movably to the guide bracket (71a) of the guide bracket (71).

For explanations, when the protrusion (72a) of the fixing bracket (72) is to be attached to or detached from the guide bracket (71a) of the guide bracket (71), if it is pushed toward a side using a finger as shown by the arrow in FIG. 3, a space is widened, and the protrusion (72a) can be inserted and detached using the widened space.

According to the embodiment, by strengthening the backrest-holding member (70) between the main body (10) and the backrest (50) as in the above, the backrest (50) is restrained stably, solving the problems of the damages mentioned previously.

Referring to FIGS. 3 to 6, on a top end portion of the backrest (50) is provided a neckrest (60) for propping and supporting the user's neck.

As an example, in the case of the embodiment, the neckrest (60) is installed at the top end portion of the backrest (50) through a second hinge (H2), and in order to restrain the neckrest (60), a neckrest-fixing member (80) comprising a fixing block (81) and a trigger piece (82) is installed in the backrest (50) and the neckrest (60).

At a center of the fixing block (81) is formed a engaging hole (81a), and in the engaging hole (81a) is detachably attached a fixing protrusion (82a) of the trigger piece (82).

In a side of the trigger piece (82) is integrally formed the fixing protrusion (82a), and the fixing protrusion (82a) is attached detachably to the engaging hole (81a) of the fixing block (81).

For explanation, when the fixing protrusion (82a) of the trigger piece (82) is to be attached to or detached from the engaging hole (81a) of the fixing block (81), as shown in the enlarged FIG. 3, the fixing protrusion (82a) can be inserted or detached from the engaging hole (81a) by pushing the trigger piece (82) to one side.

In the present embodiment, even though the neckrest (60) is fixed rotatably to the backrest (50), that is just for an example, and since it is possible to forming in structures in which the neckrest (60) can be taken out or put in through a pair of guide bars (61) on a top surface of the backrest (50) and enabling to adjust the height of the neckrest (60) easily, it is not desirable to interpret limitingly to that.

On the other hand, in case of sitting on the chair portion (13) and enjoying the sauna while leaning back to the backrest (50) and the neckrest (60), the warm heat may be delivered to feet and belly portions, but not so much to the back portion due to the backrest (50), and thus there is a problem that the sauna cannot be enjoyed to the full.

As for that, in the case of the present embodiment, the above problem can be solved by providing the back heater (100) on the backrest (50).

Referring to FIGS. 2 and 3, the back heater (100) comprises a surface-type heat generating body (101) fixed to the backrest (50) and a far-infrared radiating member (102).

The surface-type heat generating body (101) is a electro-thermal device for receiving electrical power and generating heat.

The far-infrared radiating member (102) is installed so as to be exposed to one side of the surface-type heat generating body (101), has an egg shape in general, and is made of one selected from the group consisting of tourmaline, red clay, rock salt, germanium, elvan, jade, charcoal, and ceramic.

According to the embodiment, since the back heater (100) is additionally provided to the backrest (50) as in the above, the heat can be surely delivered to the portions (for example, the back) where the heat was delivered feebly before, the user can receive heat evenly all across the entire body so as to maximizing the effect of sauna, and further can expect a therapeutic effects thanks to the ability of intensive heating on a specific portion (for example, the back).

For explanation, on a top surface of the main body (10) is installed a controller (refer to FIG. 1 and FIG. 2), through which the user can adjust temperature and turn on/off as pleased.

The operation of the invention realized as in the above is as follows.

First, in a state that a power cord (refer to FIG. 1) is inserted to the plug so as to be able to apply electrical power, the user rotates the folded backrest (50) through the first hinge (H1) in the chair portion (13), and then engages the backrest (50) to the guide bracket (71) of the backrest-holding member (70) installed in the main body (10) through the fixing bracket (72) of the backrest-holding member (70).

Next, in a state of putting up the neckrest (60) by rotating it neckrest (60) fixed rotatably to the top end portion of the backrest (50) through the second hinge (H2), the neckrest (60) is fixed to the backrest (50) through the trigger piece (82) and the fixing block (81) of the neckrest-fixing member (80).

As in the above, in a state of installing the backrest (50) and the neckrest (60), if the user opens the entrance door (11), sits on the chair portion (13) with the lower body received in the main body (10), and operates the controller (refer to FIG. 1 and FIG. 2) installed on the top portion of the main body (10), the heaters (30, 90, 100) installed in the main body (10) and the backrest (50) start to operate and generate heat, increasing the internal temperature of the main body (10) in a predetermined time period and enabling to enjoy the sauna.

Especially, when the user wants to enjoy the sauna in a more comfortable posture such as reclining, if the chair portion (13) is proceeded through the to-and-fro delivering means (40), then the backrest (50) rotates through the first hinge (H1) to recline so that the user can enjoy the sauna in a more comfortable and cozier state.

After finishing the sauna, the above may be stored in the main body (10) by going through the processes in a reverse order.

According to the present embodiment, since the chair portion (13) moves to and fro by the to-and-fro delivering means (40), even a handicapped user can position the lower body (feet) on the heater (30) easily.

Also, according to the embodiment, since the backrest (50) is reclined or stood up according to the to and fro movement of the chair portion (13) through the guide (41) and the moving member (42), the user can enjoy the sauna in a very comfortable state, and since the backrest (50) is fixed rotatably to the chair portion (13) through the first hinge (H1), after the usage, the backrest (50) can be folded and stored in the main body (10), and it can be unfolded again for another usage, which increases the easiness of storing and convenience of using.

Furthermore, according to the embodiment, since the back heater (100) is provided in the backrest (50) additionally, the heat can be surely delivered to the portions (for example, the back) where the heat was delivered feebly before, the user can receive heat evenly all across the entire body so as to maximizing the effect of sauna, and further can expect a therapeutic effects thanks to the ability of intensive heating on a specific portion (for example, the back).

While the invention has been shown and described with reference to different embodiments thereof, it will be appreciated by those skilled in the art that variations in form, detail, compositions and operation may be made without departing from the spirit and scope of the invention as defined by the accompanying claims.

### LEGEND

| | |
|---|---|
| 10: main body | 11: entering door |
| 12: propping board | 13: chair component |
| 20: sliding cover | 30: heater |
| 40: to-and-fro delivering means | 50: backrest |
| 60: neckrest | 70: backrest-holding member |
| 80: neckrest-fixing member | 90: floor heater assembly |
| 100: heater | L: far-infrared lamp |
| H1, H2: first and second | |
| hinge axis | |

1. A sauna device comprising:
a chair portion configured for moving forward or backward by a to-and-fro delivering means; and
a backrest fixed to the chair portion.

2. The sauna device of claim 1, wherein the backrest is installed rotatably in the chair portion, and wherein the backrest is configured to be lied down or raised up in relation to to-and-fro movements of the chair portion through the to-and-fro delivering means.

3. The sauna device of claim 1, wherein the to-and-fro delivering means comprises:
a propping board on which a guide is installed; and
a moving member installed on a bottom surface of the chair portion and engaging the guide movably.

4. The sauna device of claim 1, wherein a backrest-holding member is provided between the main body and the backrest, and wherein the backrest-holding member comprises:
a guide bracket installed in the main body and having a guide hole bored through a side 0 s; and
a protrusion installed in the backrest, inserted in the guide hole detachably and moving along the guide hole.

5. The sauna device of claim 1, wherein the backrest further comprises a back heater, and wherein the back heater comprises:
a 0 s-type heat-generating body fixed to the backrest; and
a far-infrared-emitting member made of one selected from the group consisting of tourmaline, red clay, rock salt, germanium, elvan, jade, charcoal, and ceramic and installed so as to be exposed to one 0 s of the 0 s-type heat-generating body.

6. The sauna device of claim 5 wherein the backrest further comprises a neckrest at a top end portion thereof.

7. The sauna device of claim 4, wherein the backrest further comprises a neckrest at a top end portion thereof.

8. The sauna device of claim 3, wherein the backrest further comprises a neckrest at a top end portion thereof.

9. The sauna device of claim 2, wherein the backrest further comprises a neckrest at a top end portion thereof.

10. The sauna device of claim 1, wherein the backrest further comprises a neckrest at a top end portion thereof.
